(19) United States
(12) Patent Application Publication
(10) Pub. No.: US 2004/0043674 A1
(43) Pub. Date: Mar. 4, 2004

(54) DSX jack including contact

(76) Inventor: Denise E. Dunne, Chanhassen, MN (US)

Correspondence Address: MERCHANT & GOULD PC, P.O. BOX 2903, MINNEAPOLIS, MN, 55402-0903, US

(21) Appl. No.: 10/232,996

(22) Filed: Aug. 28, 2002

(51) Int. Cl. H01R 13/187

(52) U.S. Cl. 439/847

(57) ABSTRACT

Methods for manufacturing center conductors for telecommunications connectors are disclosed herein. The center conductors can be manufactured by providing a generally flat precursor conductor, and by rolling the precursor conductor into a cylindrical configuration including a socket portion and a pin portion. After the rolling step, a contact corresponding to the socket portion can be plastically deformed so as to extend within a pin receptacle of the socket.

### FIELD OF THE INVENTION

The present disclosure relates generally to conductive pins for electrical connectors and to methods for manufacturing such pins. More particularly, the present disclosure relates to center conductors for coaxial telecommunications connectors and t methods for manufacturing such conductors.

### BACKGROUND

Coaxial connectors used in the telecommunications industry are typically provided with center conductors. An example center conductor 104 is shown in FIG. 14 of U.S. Pat. No. 5,417,588, which is hereby incorporated by reference in its entirety. The center conductor 104 is mounted in a dielectric housing 102 and includes a socket end 122 and a pin end 121. The center conductor 104 is manufactured using a machining process (e.g., a drill or screw machine).

### SUMMARY

The present disclosure relates to conductors for electrical connectors and to methods for making conductors for electrical conductors. It will be appreciated that the specific embodiments disclosed herein are examples of how the broad concepts of the present invention may be put into practice, and that variations can be made with respect to the described methods and conductors without departing from the broad scope of the present invention.

### BRIEF DESCRIPTION OF THE DRAWINGS

The accompanying drawings, which are incorporated in and constitute a part of the specification, illustrate examples of how certain inventions can be put into practice. A brief description of the drawings is as follows:

FIG. 1 is a front, left perspective view of a first center conductor that is an example of how certain aspects of the present invention can be put into practice;

FIG. 2 is a front view of the conductor of FIG. 1;

FIG. 3 is a left end view of the conductor of FIG. 2;

FIG. 4 is a right end view of the center conductor of FIG. 2;

FIG. 5 is a partial cross-sectional view of the center conductor of FIG. 1;

FIG. 6 illustrates a method for manufacturing the conductor of FIG. 1;

FIG. 7 illustrates a method for storing a plurality of the center conductors of FIG. 1;

FIG. 8 is a front, left perspective view of a second center conductor that is an example of how certain inventive aspects of the present disclosure can be put into practice;

FIG. 9 is a front view of the conductor of FIG. 8;

FIG. 10 is a top view of the center conductor of FIG. 9;

FIG. 11 is a bottom view of the center conductor of FIG. 9;

FIG. 12 is a left end view of the center conductor of FIG. 9;

FIG. 13 is a right end view of the center conductor of FIG. 9;

FIG. 14 is a plan view of a precursor center conductor prior to being rolled into the center conductor of FIG. 8;

FIG. 15 is a front, right perspective view of a third center conductor that is an example of how certain inventive aspects of the present disclosure can be put into practice;

FIG. 16 is a front view of the center conductor of FIG. 15;

FIG. 17 is a top view of the center conductor of FIG. 15;

FIG. 18 is a right end view of the center conductor of FIG. 15;

FIG. 19 is a plan view of a precursor center conductor prior to being rolled into the center conductor of FIG. 15;

FIG. 20 is a top view of a fourth center conductor that is an example of how certain inventive aspects of the present disclosure can be put into practice;

FIG. 21 is a cross-sectional view of the conductor of FIG. 20;

FIG. 22 is a left end view of the conductor of FIG. 20;

FIG. 23 is a right end view of the center conductor of FIG. 20;

FIG. 24 is a plan view of a precursor center conductor prior to being rolled into the center conductor of FIG. 20;

FIG. 25 is a front, right perspective view of a fifth center conductor that is an example of certain inventive aspects in accordance with the principles of the present invention;

FIG. 26 is a top view of the conductor of FIG. 25;

FIG. 27 is a front view of the center conductor of FIG. 25;

FIG. 28 is a right end view of the center conductor of FIG. 25;

FIG. 29 is a plan view of a precursor conductor prior to being rolled into the center conductor of FIG. 25;

FIG. 30 is a front, right perspective view of a sixth center conductor that is an example of how certain inventive aspects in accordance with the present disclosure can be put into practice;

FIG. 31 is a top view of the center conductor of FIG. 30;

FIG. 32 is a front view of the center conductor of FIG. 30;

FIG. 33 is a right end view of the center conductor of FIG. 30;

FIG. 34 is a left end view of the center conductor of FIG. 30;

FIG. 35 is a plan view of a precursor center conductor prior to being rolled into the center conductor of FIG. 30;

FIG. 36 is a front view of a seventh center conductor that is an example of how certain inventive aspects in accordance with the principles of the present disclosure can be put into practice;

FIG. 37 is a top view of the center conductor of FIG. 36;

FIG. 38 is a left end view of the center conductor of FIG. 36;

FIG. 39 is a right end view of the center conductor of FIG. 36; and

FIG. 40 is a plan view of a precursor center conductor prior to being rolled into the center conductor of FIG. 36.

### DETAILED DESCRIPTION

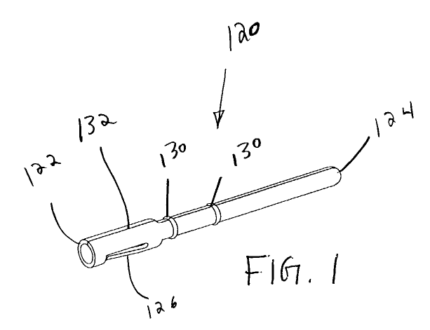

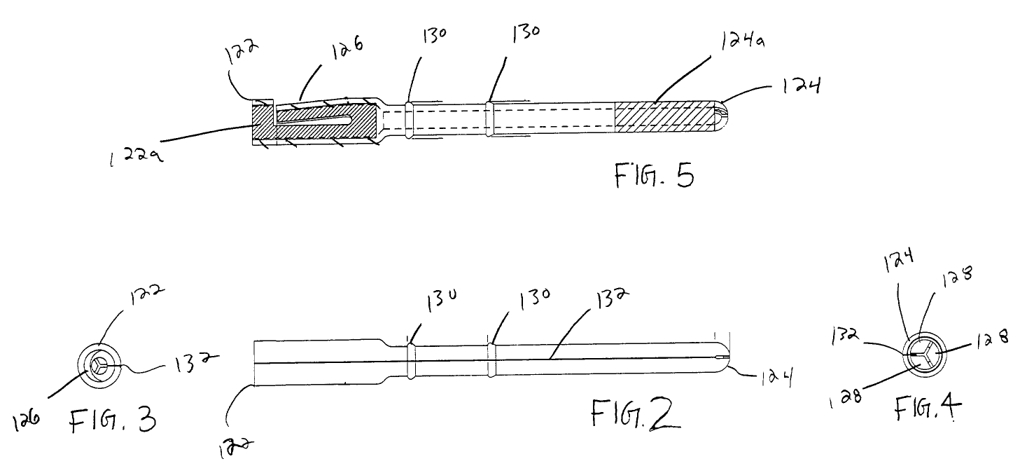

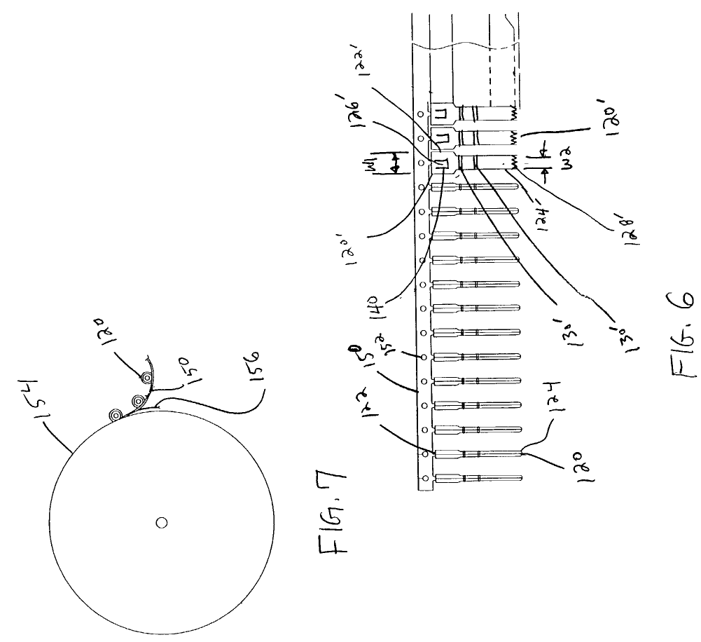

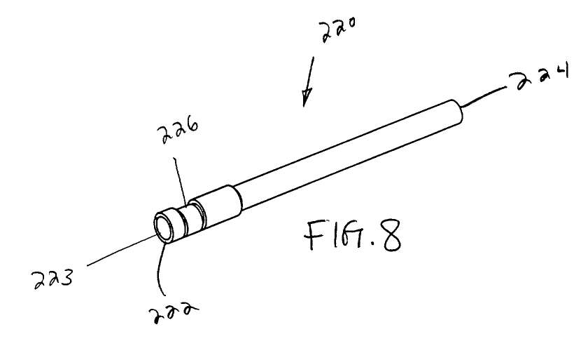

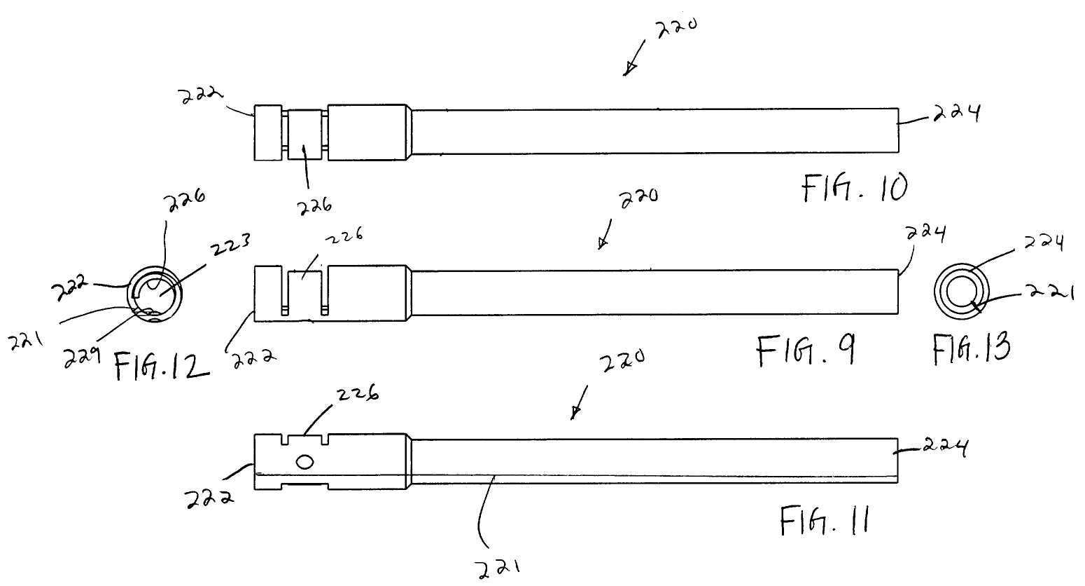

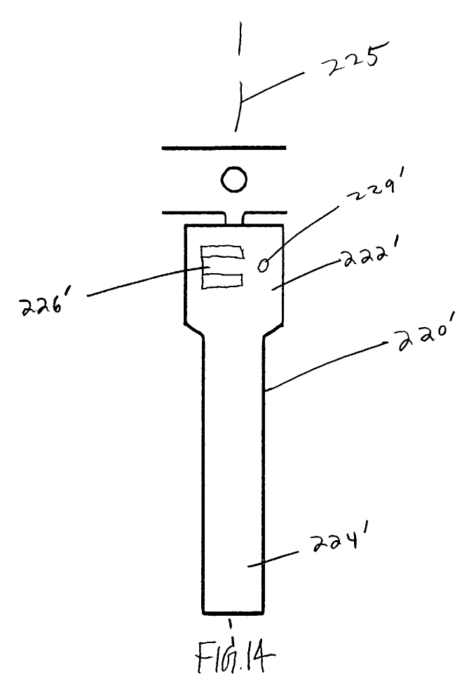

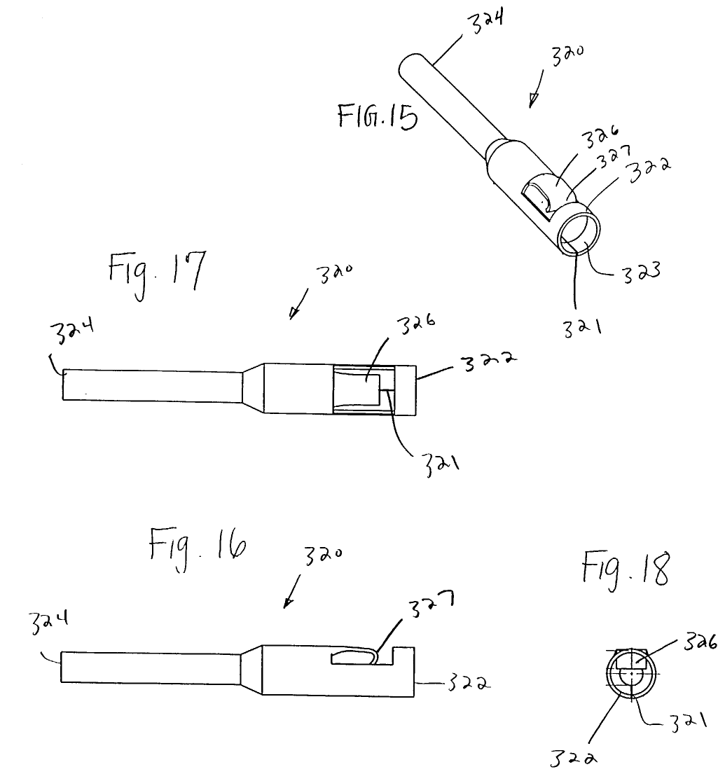

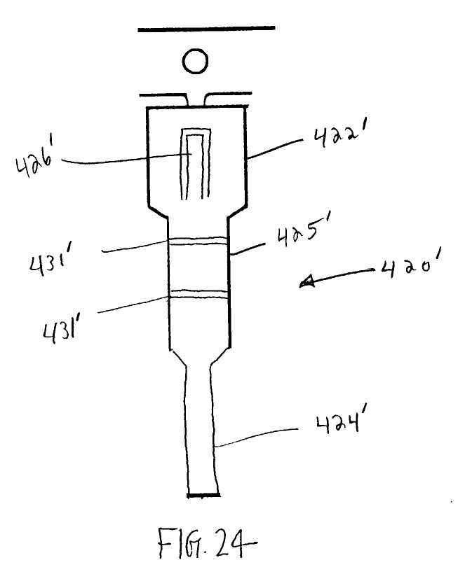

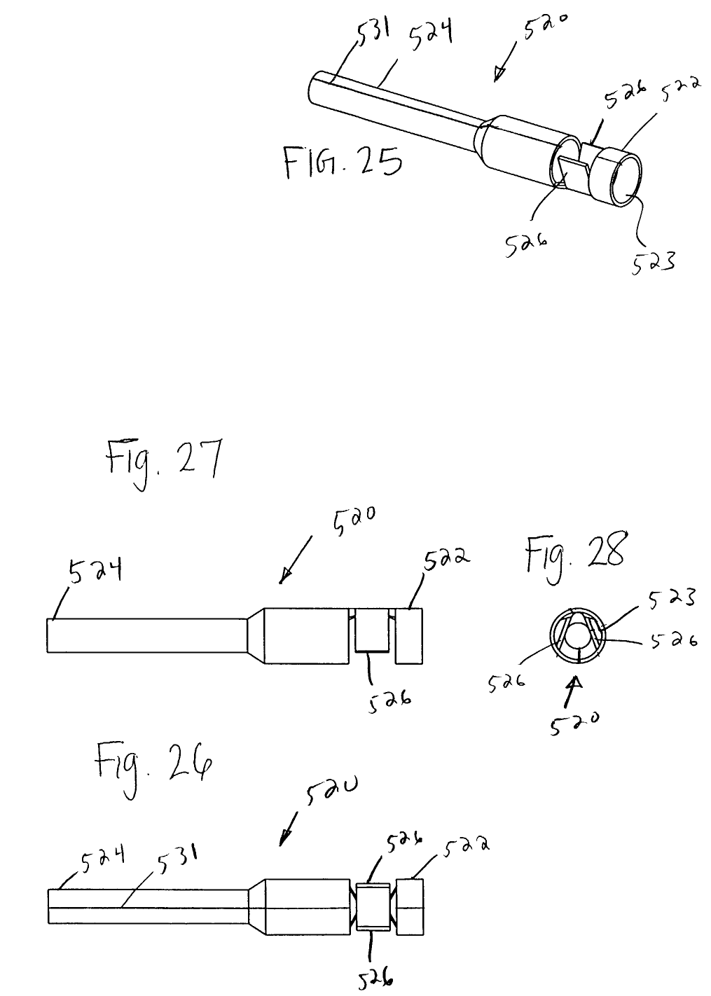

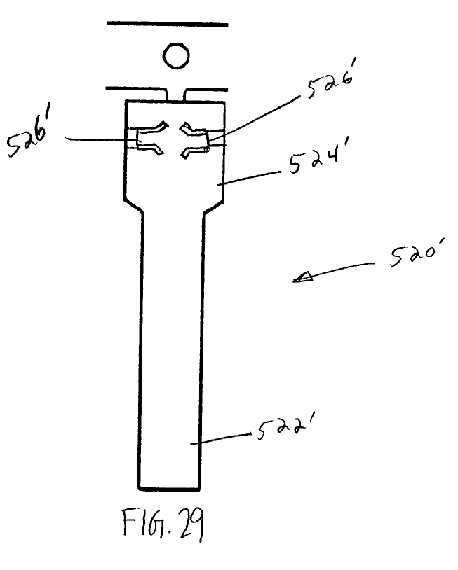

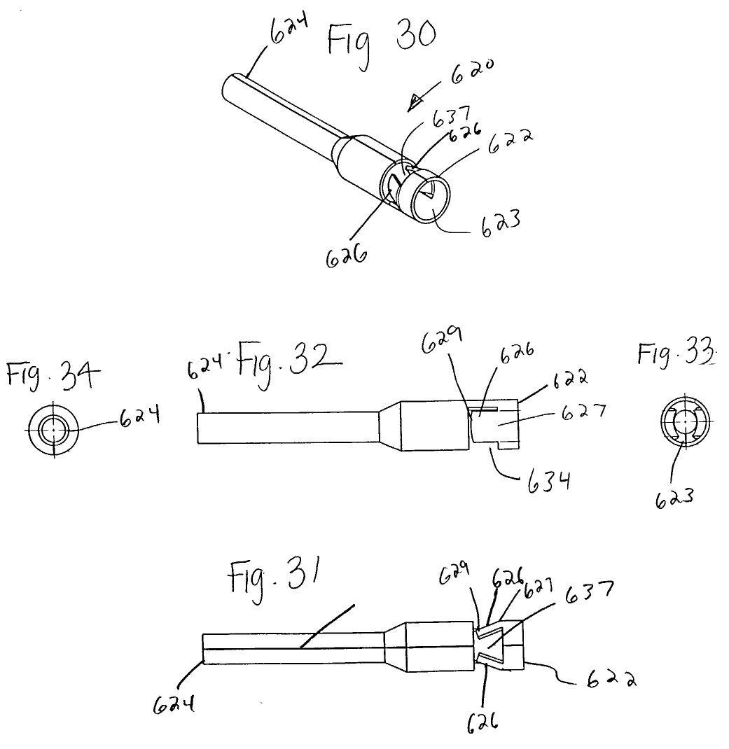

FIGS. 1-5 illustrate a first center conductor 120 that is an example of how certain inventive aspects in accordance with the principles of the present disclosure can be put into practice. The center conductor 120 includes a socket end 122 positioned opposite from a pin end 124. The socket end 122 defines an opening sized for receiving a pin of a coaxial connector. As shown schematically in FIG. 5, the interior 122a of the socket 122 is preferably coated with a conductive material such as a precious metal (e.g., gold). The socket end 122 also includes a contact tab 126 that is bent or otherwise deformed radially into the opening of the socket 122. The tab 126 is adapted to assist in making contact with a pin of a coaxial connector inserted therein.

The pin end 124 of the conductor 120 is closed by tabs 128 (see FIG. 4). As best shown in FIG. 5, a portion 124a of the exterior surface of the pin 124 is coated or plated with a conductive material such as a precious metal (e.g., gold).

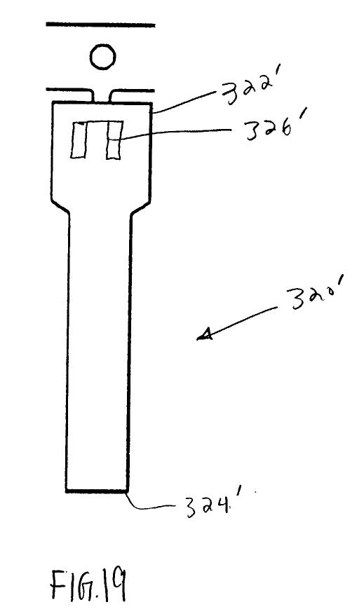

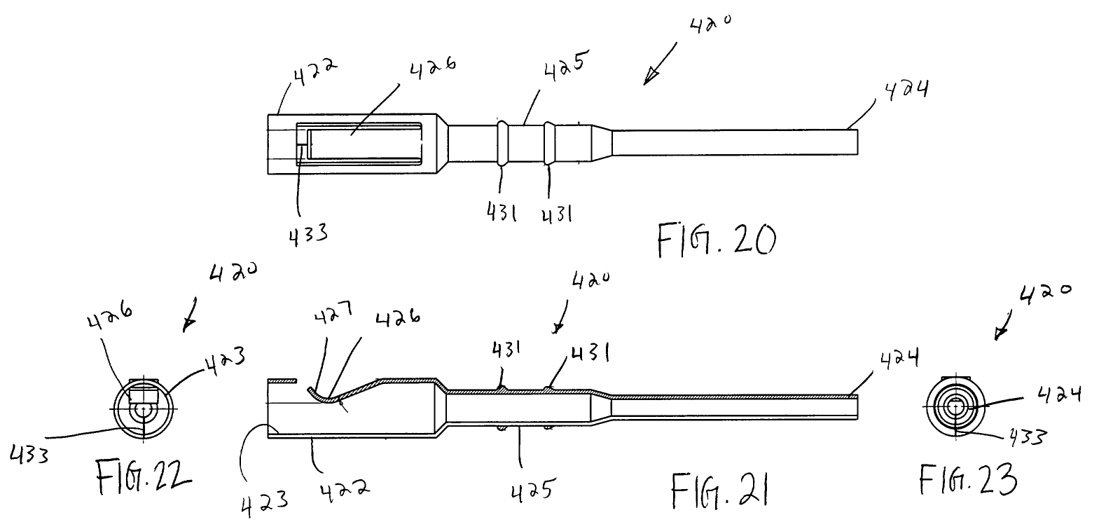

Referring to FIG. 2, the conductor 120 also includes a pair of retaining shoulders/beads 130. The shoulders/beads 130 are positioned between the socket end 122 and the pin end 124 of the conductor 120.

The conductor 120 is preferably manufactured by rolling a flat piece of material (i.e., a piece of stamped sheet metal) to form a hollow, cylindrical structure. After the rolling process, the edges of the piece of sheet metal oppose one another and define a seam 132 (see FIGS. 1 and 2) that extends axially along the entire length of the conductor 120.

While the conductor 120 can be used in any number of different types of electrical connectors, a preferred use is in coaxial telecommunications connectors such as the connector disclosed in U.S. Pat. No. 5,417,588, which is hereby incorporated by reference.

FIG. 6 illustrates precursor center conductors 120′ in the process of being manufactured into the center conductor 120. To manufacture the center conductor 120, the precursor center conductors 120′ are stamped, cut or otherwise provided from a piece of sheet metal. Each precursor conductor 120′ includes a precursor socket portion 122′ and precursor pin portion 124′. The precursor socket portion 122′ has a greater width W1 than a corresponding width W2 of the precursor pin portion 124′. Structures are stamped, cut or otherwise provided in the precursor conductors 120′ while the precursor structures 120′ are flat. For example, slits 140 are provided in the precursor socket portions 122′ so as to define precursor tab portions 126′. Additionally, precursor tab portions 128′ are provided at the precursor pin end 124′. Moreover, precursor shoulders/beads 130′ are also stamped, pressed or otherwise formed on the precursor conductor 120′.

After the various structures have been provided on the precursor conductor 120′, the precursor conductor 120′ is rolled into a cylinder as shown in FIG. 6. Additionally, the precursor tabs 128′ are bent to close the end of the pin portion 124, and the precursor tab 126′ is bent radially inward into the socket portion 122. It will be appreciated that the various wrapping/rolling, and bending or deforming steps can be made in multiple steps along an assembly line. Additionally, prior to rolling the center conductors 120, a front side of the precursor socket portion 122′ is coated/plated with a precious metal, and a back side of the precursor pin portion 124′ is coated/plated with a precious metal. To conserve precious metals, only the tip region of the precursor pin portion 124′ is plated with the precious metal. The remainder of the back side of the precursor conductor 120′ is not coated with precious metal. Similarly, on the front side of the precursor conductor 120′, only the precursor socket portion 122′ is plated with the precious metal.

Referring still to FIG. 6, a plurality of the precursor conductors 120′ and conductors 120 are shown connected to an index strip 150 by breakaway connections. The index strip 150 has openings 152 which correspond to the spacing of the conductors 120 and the precursor conductors 120′. The openings 152 facilitate automatically handling of the strip by assembly line equipment. The strip 150 also facilitates storage of the conductors 120 by allowing the conductors 120 to be wrapped in a roll 154 as shown in FIG. 7. Preferably, paper 156 is provided between each wrap of the roll to protect the conductors 120.

FIGS. 8-13 illustrate a second center conductor 220 that is an example of certain inventive aspects in accordance with the principles of the present disclosure. The conductor 220 includes a socket end 222 and a pin end 224. The socket end defines an opening 223 for receiving a pin. The socket end 222 also includes a contact tab 226. The contact tab 226 extends in a circumferential direction about a longitudinal axis of the conductor 220. The socket end 220 also includes an indent 229 (shown in FIG. 12) that projects into the opening 223 of the socket. As shown in FIG. 12, the indent 229 is positioned opposite from the circumferential tab 226. The conductor 220 includes a seam 221 (see FIGS. 11-13) that extends longitudinally along a length of the conductor 220.

The center conductor 220 is preferably made by rolling a generally flat precursor conduit such as the precursor conduit 220′ shown in FIG. 14. The precursor conduit 220′ includes a precursor socket portion 222′ and a precursor pin portion 224′. A precursor tab 226′ is cut in the precursor socket structure 222′. The precursor tab 226′ extends in a direction transverse with respect to a longitudinal axis 225 of the precursor conductor 220′. A precursor indent 229′ is also provided in the precursor socket portion 222′ by conventional techniques such as punching or stamping.

The conductor 220 is made by rolling the precursor conductor 220′ into a cylinder. The precursor tab portion 226′ is then bent at a smaller radius than the curvature of the socket portion 222 such that the tab 226 projects into the opening 223 of the socket 224. Prior to rolling the precursor conductor 220′, the precursor conductor 220′ can be plated with a precious metal as previously described with respect to the first embodiment.

FIGS. 15-18 show a third center conductor 320 that is an example of certain inventive aspects in accordance with the principles of the present disclosure. The conductor 320 includes a socket 322 and a pin 324. The socket 322 includes an opening 323 for receiving a pin. The socket 322 also includes a contact tab 326 that projects into the opening 323. The contact tab 326 has a free end 327 that is bent radially inwardly into the opening 323 in a hook-like configuration (see FIG. 16). A seam 321 extends along the length of the conductor 320.

The conductor 320 is preferably manufactured by initially providing a planar, precursor conductor such as precursor conductor 320′ shown in FIG. 19. The precursor conductor 320′ includes a precursor socket portion 322′ and a precursor pin portion 324′. The precursor socket portion 322′ has been cut so as to define a precursor contact tab 326′. The conductor 320 can be manufactured by rolling the precursor conductor 320′ into a cylinder, and by deforming the precursor contact tab 326′ radially inwardly. Similar to the other embodiments, selected portions of the precursor conductor 320′ can be plated with a precious metal conductor prior to the rolling process.

FIGS. 20-23 illustrate a fourth center conductor 420 that is an example of how certain inventive aspects in accordance with the principles of the present disclosure can be put into practice. The conductor 420 includes a socket portion 422, a pin portion 424, and an intermediate portion 425 positioned between the socket portion 422 and the pin portion 424. The intermediate portion 425 has a diameter that is larger than the diameter of the pin portion 424 and smaller than the diameter of the socket portion 422. The socket portion includes a central opening 423 for receiving a pin, and a contact 426 that projects into the opening 423. The contact 426 has a cantilevered configuration. The contact 426 is bent radially inwardly at its base end so as to project into the opening 423. A free end 427 of the contact 426 curves radially outwardly (see FIG. 21).

Referring still to FIGS. 20-23, two shoulders 431 are provided on the intermediate portion 425 of the conductor 420. Additionally, the conductor 420 defines a seam 433 positioned opposite from the contact 426.

FIG. 24 is a plan view of a precursor conductor 420′ that is rolled from its planar form to provide the conductor 420. The precursor conductor 420′ includes a precursor socket portion 422′, a precursor pin portion 424′, and a precursor intermediate portion 425′. Precursor shoulders 431′ are provided on the precursor intermediate portion 425′. Additionally, the precursor socket portion 422′ is cut, slit stamped or otherwise provided with openings that define a precursor contact 426′.

To manufacture the conductor 420, the precursor conductor 420′ is plated at selected regions with a conductor such as a precious metal, and then rolled into a cylindrical configuration. After rolling the precursor conductor 420′ into a cylinder, the precursor contact 426′ is deformed radially inwardly so as to define the contact 426.

FIGS. 25-28 depict a fifth conductor 520 that is an example of how certain inventive aspects in accordance with the principles of the present invention may be practiced. The conductor 520 includes a socket portion 522 and a pin portion 524. The socket portion 524 defines a central opening 523 adapted for receiving a contact pin of another connector. The socket 522 includes opposing contacts 526 aligned at acute angles relative to one another. The contacts 526 are integral with the socket portion 522 at a location opposite from a longitudinal seam 531 of the conductor 520.

Similar to the previous embodiments, the conductor 520 is preferably manufactured using a rolling processing in which a flat precursor conductor is rolled into the shape of FIGS. 25-28 during one or more rolling/forming steps. FIG. 29 depicts an exemplary planar, precursor conductor 520′ adapted for manufacturing of a conductor 520. The precursor conductor 520′ includes a precursor socket portion 522′ and a precursor pin portion 524′. Openings are provided in the precursor socket portion 522′ (e.g., by a process such as cutting, stamping or pressing). The openings define precursor contacts 526 on the precursor socket portion 522′. The contacts 526 have a V-shaped configuration. As shown in FIG. 28, the contacts 528 extend in a chord-like manner across the opening 523 of the socket 522.

To manufacture the conductor 520, selected regions of the precursor conductor 520′ are plated with a material such as a precious metal, and the precursor conductor 520′ is then rolled into a generally cylindrical shape as shown in FIGS. 25-28 by one or more rolling steps. Thereafter, the contacts 526 can be plastically deformed so as to assume the positions depicted in FIGS. 25-28.

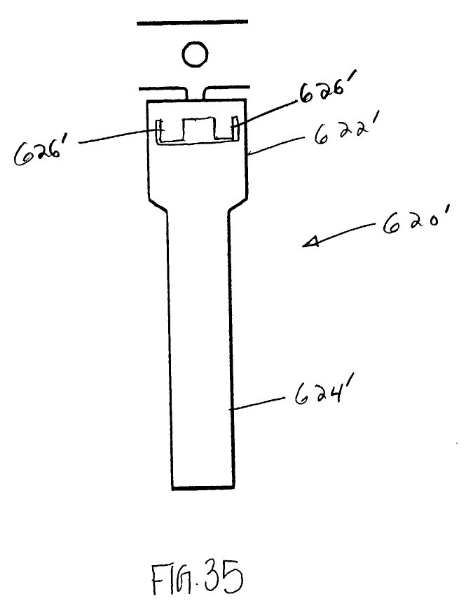

FIGS. 30-34 depict a sixth conductor 620 that is an example of certain inventive concepts in accordance with the principles of the present disclosure. The conductor 620 includes a socket portion 622 and a pin portion 624. The socket portion 622 defines a central opening 623 adapted for receiving a conductive pin of another connector. An open region 637 is defined through the socket portion 522. Two opposing contacts 626 project into the opening 523. The contacts 626 have base ends 627 and free ends 629. The contacts 626 are aligned at oblique angles relative to one another and converge towards one another as the contacts extend toward the pin portion 624 (see FIG. 31).

Similar to the previous embodiments, the conductor 620 can be manufactured by using a rolling process to form a planar precursor conductor into a cylindrical shape. FIG. 35 depicts a precursor conductor 620′ suitable for manufacturing the conductor 620. The precursor conductor 620′ includes a precursor socket 622′ and a precursor pin 624′. A portion of the precursor socket 622′ has been removed so as to define two precursor contacts 626′. To manufacture the conductor, the precursor conductor 520′ is rolled to the configuration of FIGS. 30-34. Thereafter, the precursor contacts 626′ are deformed radially inwardly to match the configuration best shown in FIG. 31. Similar to previous embodiments, selected regions of the precursor conductor 620′ can be plated with a metal material such as a precious metal.

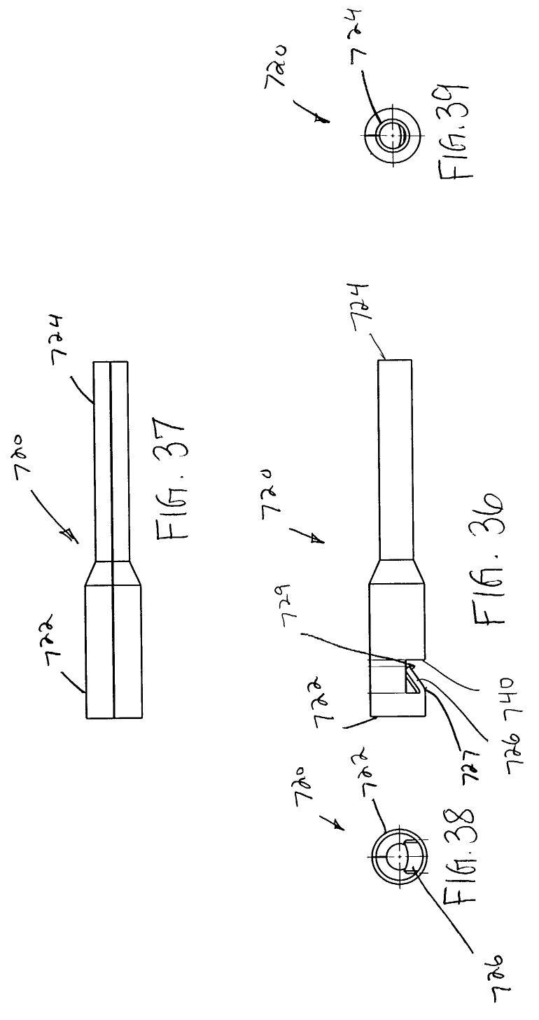

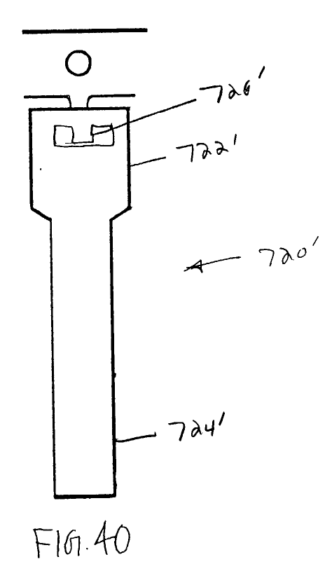

FIGS. 36-39 illustrate a seventh conductor 720 that is an example of how certain inventive aspects in accordance with the principles of the present disclosure can be put into practice. The conductor 720 includes a socket portion 722 and a pin portion 724. An opening 740 has been cut or otherwise provided in the side wall of the socket portion 722. A contact 726 projects through the opening into the interior of the socket 722. The contact 726 has a base end 727 connected to the socket wall and a free end 729 that projects into the interior of the socket 722.

Similar to the previous embodiments, the conductor 720 can be manufactured by rolling or otherwise forming a flat, precursor structure into a cylindrical conductor. FIG. 40 illustrates an example precursor conductor 720′ adapted for making the conductor of FIGS. 36-39. The precursor conductor 720′ includes a precursor socket wall 722′ and a precursor pin 724′. A portion of the precursor socket wall 722′ has been removed so as to provide a precursor contact 726′ having a base end connected to the precursor socket wall 722′ and an unattached free end. The conductor 720 is manufactured by rolling or otherwise forming the precursor conductor 720′ into a generally cylindrical configuration. Thereafter, the precursor contact 726′ can be inelastically deformed through the opening in the socket wall and into the pin receptacle of the socket portion 722. Prior to rolling the precursor conductor 720′, a metal such as a precious metal can be plated on selected regions of the precursor socket wall 722′ and the precursor pin wall 724′. The contact 726 is oriented such that its free end is closer to the conductor pin 724 than its base end.

It will be appreciated that the embodiments disclosed herein are merely examples, and that variations can be made without departing from the broad inventive scope of the present disclosure.

While it is preferred for a rolling process to be used to manufacture the various conductors disclosed herein, it will be appreciated that for at least certain embodiments, other manufacturing techniques such as machinings could also be used. Further, in certain non-limiting embodiments, the planar precursor conductors can be made of a sheet metal material such as phosphorous bronze or beryllium copper.

We claim:

1. A method for making a conductor comprising:
providing a precursor conductor having a precursor socket portion and a precursor pin portion, the precursor socket portion defining a precursor contact;
rolling the precursor conductor such that the precursor socket portion defines a socket of the conductor and the precursor pin portion defines a pin of the conductor; and
deforming the precursor contact radially inwardly into a pin receptacle defined by the socket.

2. The method of claim 1, further comprising plating the precursor socket portion with a precious metal prior to the rolling step.

3. The method of claim 1, further comprising plating a portion of the precursor pin portion with a precious metal prior to the rolling step.

4. The method of claim 1, wherein the precursor conductor is provided with at least two precursor contacts, and wherein both of the precursor contacts are deformed so as to extend within the pin receptacle of the socket.

5. The method of claim 1, wherein the precursor conductor is deformed along a curved path that extends circumferentially about the socket.

6. The method of claim 1, wherein the precursor contact is deformed into a hook-like configuration.

7. A conductor comprising:
a connector body including a socket portion and a pin portion, the socket portion defining an internal pin receptacle, the socket portion also including a contact that extends from a socket wall into the pin receptacle, the conductor body defining a seam that extends longitudinally along the length of the conductor body through both the socket portion and the pin portion.

8. The conductor of claim 7, wherein the contact extends in a circumferential direction about the socket portion.

9. The conductor of claim 7, wherein the contact extends in an axial direction along the connector body.

10. The conductor of claim 7, wherein the socket portion includes at least two contacts that extend into the pin receptacle.

11. The conductor of claim 7, wherein the contact has a cantilevered configuration including a base end that is integral with the socket wall and a free end.

12. The conductor of claim 11, wherein the contact extends from the base end toward the pin portion of the contact.

13. The conductor of claim 11, wherein the contact is curved in a hook-like configuration.

14. The conductor of claim 7, wherein a distal most end of the contact projects farthest into the pin receptacle.

15. The conductor of claim 7, wherein the contact has a convex curvature adapted to contact a pin inserted within the pin receptacle.

16. A conductor comprising:
a conductor body including a socket portion defining a pin receptacle, the socket portion also including an electrical contact that extends in a circumferential direction about a longitudinal axis of the conductor body.
